(19) United States
(12) Patent Application Publication
(10) Pub. No.: US 2007/0274543 A1
(43) Pub. Date: Nov. 29, 2007

(54) Multifunction-Type Vibration Actuator And Mobile Terminal Device

(76) Inventors: Minoru Ueda, Tokyo (JP); Shoichi Kaneda, Tokyo (JP); Kenji Ueno, Tokyo (JP)

Correspondence Address: NIXON PEABODY, LLP, 401 9TH STREET, NW, SUITE 900, WASHINGTON, DC, 20004-2128, US

(21) Appl. No.: 10/592,957

(22) PCT Filed: Mar. 18, 2005
(86) PCT No.: PCT/JP05/04909

§ 371 Date: Sep. 15, 2006

(30) Foreign Application Priority Data
Mar. 22, 2004 (JP) 2004082328

(51) Int. Cl. H04R 1/00

(52) U.S. Cl. 381/162

(57) ABSTRACT

[Problems]To provide a multifunction-type vibration actuator and a mobile terminal device capable of decreasing the lowest acoustic resonance frequency and preventing breakage of a coil lead as well as improving acoustic characteristics and preventing sound leaks. [Means for Solving Problems]
A portion near the outer periphery of a diaphragm 3 is bent to form a rising portion 3b extending along an inner periphery 1a of a housing 1 toward an open end thereof. This rising portion 3b serves as a corrugation to decrease the lowest resonance frequency and the amplitude of vibration of which a fulcrum is served by the rising portion 3b is not so large as that of the corrugation. Accordingly, the coil lead of a voice coil 4 is not easily broken. Furthermore, an extending portion 3c is formed to extend outward along a flat surface 1b formed at the open end of a housing 1 from a rising portion 3b. This enlarges the entire radius of the diaphragm 3 and improves the acoustic characteristics. Moreover, by arranging a flat surface 1b of a housing 1 parallel to an extending portion 3c of a diaphragm 3, a gasket can easily be attached.

### TECHNICAL FIELD

This invention relates to a multifunction-type vibration actuator mounted on a mobile terminal device, such as a mobile phone and a small information communication terminal, and alerts a user to an incoming call with sound or vibration from one device and a mobile terminal device mounted with that actuator. More specifically, this invention relates to a multifunction-type vibration actuator in a housing assembled with a magnetic circuit part, a diaphragm facing this magnetic circuit part, a voice coil fixed to this diaphragm and inserted into a magnetic gap of the magnetic circuit part, and a suspension for supporting the magnetic circuit part, and an outer periphery of the diaphragm is fixed to an open end of the housing to cover the housing.

### BACKGROUND ART

Conventionally, this type of multifunction-type vibration actuator has an outer periphery of a diaphragm contacts a stepped section formed at an open end of a housing bonded on the stepped section, one surface of a voice coil is bonded to a back face of an annular mounting section formed in the center of the diaphragm supported by the back face and is inserted into a magnetic gap of a magnetic circuit part, lead wires of this voice coil are adhesively attached to the back face of the diaphragm, and the ends of the lead wires are electrically connected to a terminal plate (power supply terminal) provided on the outside of the diaphragm (see, for example, Patent Reference 1). In this actuator, transmission of a voice signal to the voice coil fixed to the diaphragm initiates vibration of the diaphragm to generate sound, such as an incoming call alert, a melody, voice or music, and transmission of a signal with a vibration frequency initiates vibration of a mechanical vibration system consisting of the magnetic circuit part and a suspension to transmit this vibration throughout a mobile terminal device mounted with this multifunction-type vibration actuator through the housing.

[Patent Reference] JP2002-191092A (FIGS. 2-3 and 6 on pages 2-4)

### DISCLOSURE OF THE INVENTION

### Problem Solved by the Invention

In this type of multifunction-type vibration actuator, size reduction is promoted and specifications equivalent to a conventional larger actuator is required at the same time. Since significant difficulty in obtaining the necessary acoustic characteristics results from fixation of a diaphragm using conventional technology, the development of new method for fixing the diaphragm is required. More specifically, the conventional method of fixation has the following problems:

1. Decreasing the lowest resonance frequency (f₀: f zero) by providing the diaphragm with corrugation results in larger amplitude associated with vibration of the diaphragm. Therefore, the lead wires of a voice coil bonded to an inner surface of the diaphragm are easily broken, leading to poor durability.

2. The outer periphery of the diaphragm bonded to a stepped section of the diaphragm decreases a radius of the whole diaphragm, leading to difficulty in obtaining the necessary acoustic characteristics.

3. Putting a gasket, such as a sponge, between the diaphragm and an open end of the housing for the purpose of preventing sound leakage as required results in difficulty in bonding the gasket because the open end of the conventional housing has a stepped portion.

This invention solves the above problems and provides a multifunction-type vibration actuator and a mobile terminal device that simultaneously realize a decrease in the lowest resonance frequency and prevention of coil lead wire breakage, improve acoustic characteristics, and provide a technique for easily preventing sound leakage.

### Means for Solving the Problem

In order to achieve the aforementioned purposes, the invention according to claim 1 provides a multifunction-type vibration actuator, wherein a portion close to the outer periphery of the diaphragm is bent along an inner periphery of the housing to form a rising portion extending toward the open end, an extending surface extending outward along a flat surface formed at the open end of the housing from the rising portion is formed by bending, and the flat surface of the housing and the extending surface of the diaphragm are arranged and bonded so as to be parallel while facing each other.

The invention according to claim 2 provides a mobile terminal device incorporating the multifunction-type vibration actuator according to claim 1, wherein a received call-out signal initiates vibration of one or both mechanical vibration systems consisting of the diaphragm, the magnetic circuit part, and the suspension, and vibration of the mechanical vibration systems is transmitted throughout the device through the housing, and reset of the call-out signal stops vibration of the housing and the mechanical vibration systems.

### Effects of the Invention

In this invention, a portion of a diaphragm close to an outer periphery thereof is bent at an angle of approximately 90-110 degrees to form a rising portion extending toward an opening end along an inner periphery of a housing, enabling a decrease in the lowest resonance frequency (f₀: f zero) because this rising portion serves as corrugation. At the same time, since the amplitude of the vibration of which a fulcrum is served by the proximal end of the rising portion is not high in comparison with that of the corrugation, breakage of lead wires of a voice coil can be prevented even at high amplitude, leading to high durability. Furthermore, formation of an extending portion extending outward along a flat surface formed at an open end of the housing from this rising portion increases a radius of a whole vibration plate to improve acoustic characteristics. By making the flat surface of the housing face parallel to the extending portion of the diaphragm, a gasket, such as a sponge, can be bonded to prevent sound leakage.

### BEST MODE FOR CARRYING OUT THE INVENTION

A multifunction-type vibration actuator A according to this invention comprises a housing 1, a magnetic circuit part 2 inside a housing 1, a diaphragm 3 facing a magnetic circuit part 2, a voice coil 4 fixed to a diaphragm 3 and inserted into an annular magnetic gap 2a of a magnetic circuit part 2, and a suspension 5 for supporting the magnetic circuit part, wherein entry of a voice signal into a voice coil 4 initiates a small vibration of a diaphragm 3 to generate a sound, such as an incoming call alert, a melody, voice, and music, and the flow of signal current at a vibration frequency of 120-160 Hz initiates the large vibration of a mechanical vibration system with a weight including a magnetic circuit part 2 and a suspension 5 as shown in FIGS. 1 and 4.

Embodiments of this invention are described using diagrams.

### Embodiment 1

In embodiment 1, a flat annular mounting section 3a is formed in a diaphragm 3 almost in the middle between the center of a diaphragm 3 and the outer periphery of a diaphragm 3, the portion close to the outer periphery of a diaphragm 3 is bent in parallel with and along an inner peripheral surface 1a to form an annular rising portion 3b extending toward an open end of a housing 1, an extending section 3c extending outward from this rising portion 3b along a flat surface 1b formed at the open end of a housing 1, and a flat surface 1b of a housing 1 is allowed to face and be parallel with an extending section 3c of a diaphragm 3 to be fixed to each other.

This diaphragm 3 is a vibration plate formed as a circular plate with an appropriate thickness made from an elastic material of plastic film, such as polycarbonate, polyetherimide, polyimide, and polyethylene terephthalate. The open end of a voice coil 4 is bonded to a back face of the annular mounting portion 3a formed almost in the middle between the center of a diaphragm 3 and the outer periphery of a diaphragm 3 with adhesive, a voice coil 4 is inserted into a magnetic gap 2a, and further concentric curved surfaces 3d and 3e are formed by bending at the center and the outer periphery of a coil mounting portion 3a as shown in FIGS. 1 through 3.

A voice coil 4 is cylindrically wound of which lead wires 4a are bonded on the back face of a diaphragm 3 with adhesive to avoid the effects of vibration as shown in FIG. 2. The distal ends of these lead wires 4a are pulled out toward a terminal block 1c provided to the outside of a housing 1 and are electrically connected to a terminal plate 6 provided to a terminal block 1c by soldering or bonding.

A housing 1 is a cylindrical enclosure for accommodating the above-described magnetic circuit part 2. One open end of a housing 1 is provided with a flat surface 1b on which an extending portion 3c of a diaphragm 3 is bonded with adhesive. Another open end 1d is detachably installed and covered with a cylindrical bottom cover 7 having a bottom. An inner periphery 1a of a housing 1 is provided with an annular overhang wall 1e to be in contact with a magnetic circuit part 2 during vibration. Another open end 1d extending from this inner periphery 1a is provided with a retaining means for supporting an outer end section 5c of a suspension 5.

A suspension 5 is formed as an annular leaf spring of which a central part is provided with a central opening 5a to be fitted with a magnetic circuit part 2 to be described later, an annular section 5b surrounding this central opening 5a and in contact with a magnetic circuit part 2, and an arm 5d elastically deformed while communicating an annular section 5b and an outer end section 5c. An annular section 5b is integrally bonded to a magnetic circuit part 2 with adhesive or by laser welding and an outer end section 5c is installed on the other open end 1d of a housing 1 with the aforementioned fixing means to support a magnetic circuit part 2 at a position facing a diaphragm 3.

In this embodiment, as a fixing means for immobily supporting an outer end section 5c of a suspension 5, an outer end section 5c of this suspension 5 is annularly formed, the upper surface thereof is in contact with the other open end 1d of a housing 1, and an annular elastic body 8, such as an O-ring, is inserted between the bottom of an annular outer end section 5c and a bottom cover 7 covering the other open end 1d of a housing 1 to retain a housing 1 and an outer end section 5c of a suspension 5.

A magnetic circuit part 2 is configured by concentrically stacking a yoke 9, a disk-shaped magnet 10, and a disk-shaped pole piece 11.

A yoke 9 is made of a magnetic material and formed as a cylinder with a bottom. An outer peripheral surface 9a of a yoke 9 is formed to provide a small gap (for example, 0.05-0.2 mm) with an inner peripheral surface 1a of a housing 1. A contact section 9b facing an annular overhang wall 1e formed in an inner peripheral surface 1a of a housing 1 is provided in contact with the annular overhang wall 1e of a housing 1 during vibration of a magnetic circuit part 2 to restrict movement of a magnetic circuit part 2 caused by an external shock force.

Furthermore in this embodiment, the bottom of a yoke 9 is provided with a raised surface 9c fitting into a central opening 5a of a suspension 5, and an annular section 5b of a suspension 5 is in contact with and integrally bonded to a support surface 9d formed around the raised surface 9c with adhesive or by laser welding. A counter bore (not illustrated) with a diameter slightly larger than that of a magnet 10 can be provided in order to position a magnet 10 at the center of the bottom if necessary.

A pole piece 11 is formed as a disk with a diameter equal to or larger than that of a magnet 10. The bottom of a pole piece 11 can be provided with a counter bore (not illustrated) with a diameter slightly larger than that of a magnet 10 in order to position a magnet 10 if necessary. It is preferable that a magnet 10 is retained between this counter bore and the counter bore of a yoke 9 to restrict a radial shift of a magnet 10.

Now, performance of such multifunction-type vibration actuator A is described. Application of a voice signal current from a terminal plate 6 through a lead wire 4a allows a voice coil 4 to generate an electromagnetic force acting on a yoke 9, magnet 10, and pole piece 11 of a magnetic circuit part 2 to repeat magnetic attraction and repulsion between them and to start vibration according to the Fleming's left hand rule. In association with this, the curved surfaces of 3d and 3e of a diaphragm 3 bonded with a voice coil 4 start vibration of a fulcrum of which is served by a lower end 3b′ of the rising portion 3b.

The small vibration of this diaphragm 3 generates an incoming call alert, melody, voice, and music. A suspension 5, however, seldom vibrates because of a different natural frequency.

Vibration of a diaphragm 3 at this voice signal generation enables a decrease in the lowest resonance frequency (F₀: f zero) because this rising portion 3b serves as usual corrugation. At the same time, since an amplitude of vibration of which a fulcrum is served by a lower end 3b′ of a rising portion 3b is not as high as the usual corrugation, a lead wire 4a from a voice coil 4 routed along a diaphragm 3 can avoid breakage even if the amplitude is increased. In addition, substantial enlargement of a radius of a whole vibration plate by an extending section 3c extending outward from this rising portion 3b improves the acoustic characteristics.

On the other hand, when a signal applied to a voice coil 4 has a vibration frequency (for example, 120-160 Hz), a diaphragm 3 seldom vibrates, which reduces sound volume. On the other hand, vibration of a magnetic circuit part 2 supported by a suspension 5 increases.

Since a mechanical vibration system consisting of a magnetic circuit part 2 and a suspension 5 provides high vibration energy dependent on its large mass, the generated vibration is transmitted to the whole mobile terminal device (not illustrated) mounted with a multifunction-type vibration actuator A through a housing 1 to alert a user to an incoming call. Thus, one sound production structure provides two types of action: sound production and vibration.

### Embodiment 2

In this embodiment 2, an annular mounting section 3a with a rectangular cross-section and an open top is partially formed at a position almost in the middle between the center and the outer periphery of a diaphragm 3, a voice coil is installed on a flat surface thereof, a portion close to the outer periphery of this diaphragm 3 is obliquely bent along an inner peripheral surface 1a of a housing 1 to form an annular rising portion 3b extending toward an open end of the housing 3, and an extending section 3c extending outward from this rising portion 3b along a flat surface 1b is formed at an open end of a housing 1 as shown in FIG. 4. Except for these configurations, the embodiment 2 is identical to the embodiment 1 shown in FIGS. 1 through 3.

Therefore the embodiment 2 shown in FIG. 4 produces operational effects similar to those of the embodiment 1 shown in FIGS. 1 through 3.

In addition, in this embodiment 2, tongues (not illustrated) circumferentially and equally spaced are provided to the outer peripheral section 5c of a suspension 5 as a retaining means for supporting an outer end section 5c of a suspension 5 as disclosed by JP2002-191092A. By inserting and bonding these tongues in notches (not illustrated) formed in the inner peripheral surface of a housing 1, a magnetic circuit part 2 is elastically supported by a housing 1 through a suspension 5 in a hanging condition.

The shape of the above-described diaphragm 3 is not limited to the illustrated example. If the shape has at least a rising portion 3b and an extending portion 3c, a modification is acceptable. Moreover, the configuration and shape consisting of a housing 1, a magnetic circuit part 2, a voice coil 4 and a suspension 5 are not limited to those illustrated. If functions similar to those described above are satisfied, other configurations and shapes are acceptable.

### BRIEF DESCRIPTION OF THE DRAWINGS

FIG. 1 is a cross-sectional front view of a multifunction-type vibration actuator showing one embodiment according to the invention.

FIG. 2 is a reduced top view of the above actuator.

FIG. 3 is an exploded perspective view.

FIG. 4 is a cross-sectional front view of a multifunction-type vibration actuator showing another embodiment according to the invention.

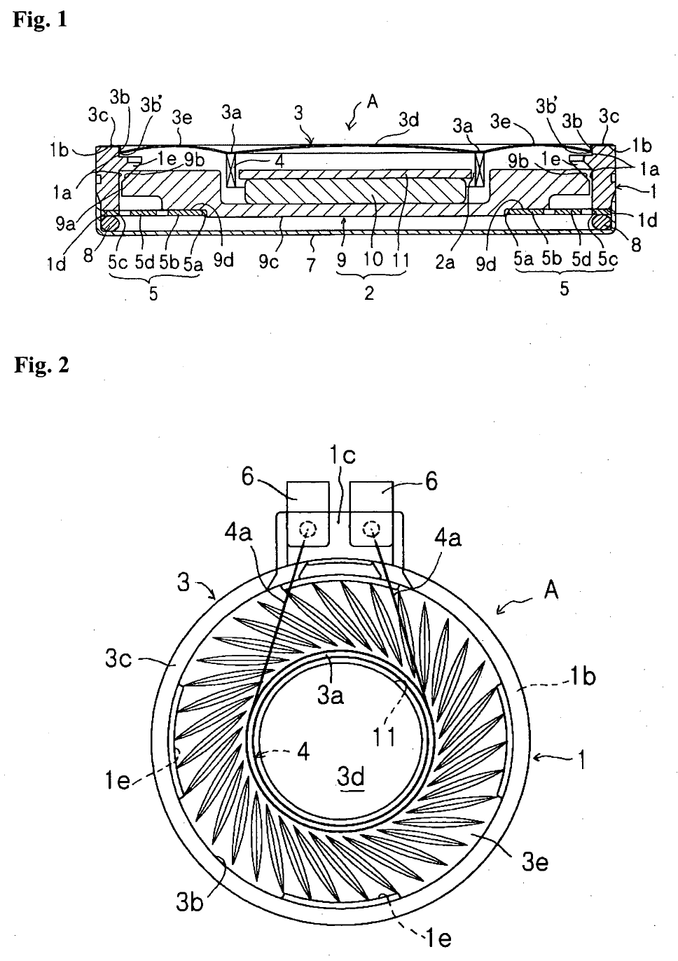

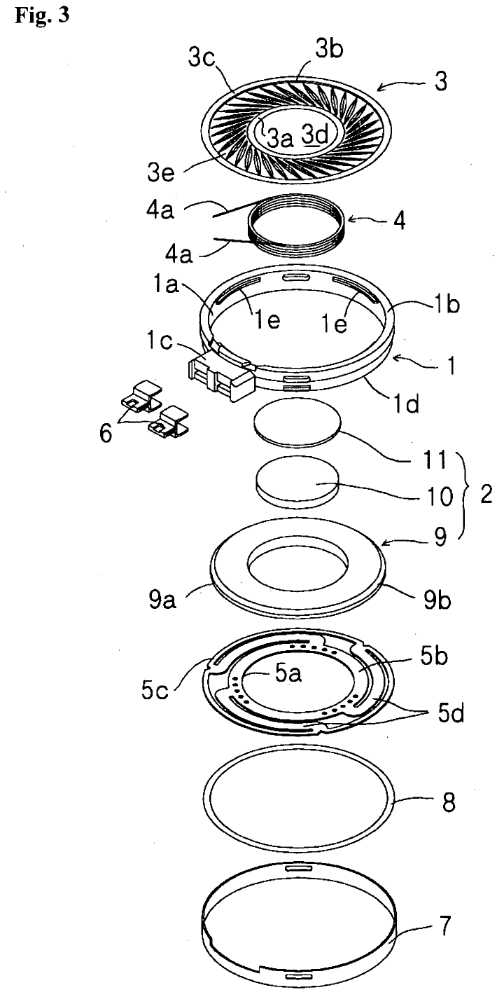

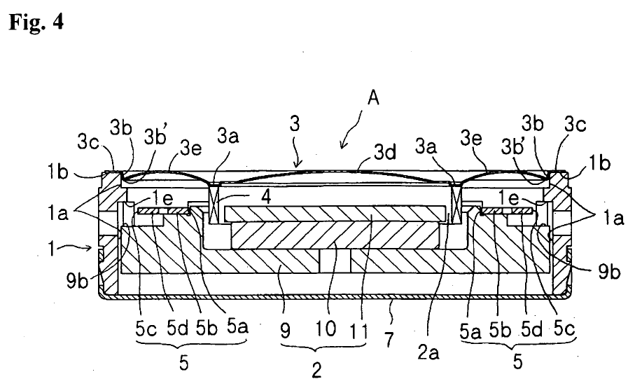

### DESCRIPTION OF REFERENCE CHARACTERS

A Multifunction-type vibration actuator
1 Housing
1a Inner peripheral surface
1b Flat surface
2 Magnetic circuit part
2a Magnetic gap
3 Diaphragm
3b Rising portion
3c Extending portion
4 Voice coil
5 Suspension

1. A multifunction-type vibration actuator comprising a housing (1), a magnetic circuit part (2) inside said housing (1), a diaphragm (3) arranged facing said magnetic circuit part (2), a voice coil (4) fixed to said diaphragm (3) and inserted into a magnetic gap (2a) of said magnetic circuit part (2), and a suspension (5) for supporting said magnetic circuit part (2), wherein an outer periphery of said diaphragm (3) is fixed to an open end of said housing (1) to cover said housing (1), a portion close to said outer periphery of said diaphragm (3) is bent along an inner periphery (1a) of said housing (1) to form a rising portion (3b) extending toward said open end, an extending surface (3c) extending outward along a flat surface (1b) formed at said open end of said housing (1) from said rising portion (3b) is formed by bending, and said flat surface of said housing (1) and said extending surface of said diaphragm (3) are arranged and bonded so as to be parallel while facing each other.

2. A mobile terminal device incorporating said multifunction-type vibration actuator (A) according to claim 1, wherein a received call-out signal initiates vibration of one or both mechanical vibration systems including said diaphragm (3), said magnetic circuit part (2) and said suspension (5), vibration of said mechanical vibration systems is transmitted throughout said device through said housing (1), and reset of said call-out signal stops vibration of said diaphragm (3) and said mechanical vibration systems.
